(19) United States
(12) Patent Application Publication
(10) Pub. No.: US 2005/0278065 A1
(43) Pub. Date: Dec. 15, 2005

(54) Nutritional informative vending machine providing a remote nutrition informing system

(76) Inventor: Alvaro Garza, Irving, TX (US)

Correspondence Address: Thomas S. Kim;ROSENBAUM & ASSOCIATES, P.C., Suite #380, 650 Dundee Road, Northbrook, IL, 60062, US

(21) Appl. No.: 10/865,223

(22) Filed: Jun. 10, 2004

(51) Int. Cl. B65H 1/00; G06F 17/00; B65G 59/00; G07F 11/00

(52) U.S. Cl. 700/237

(57) ABSTRACT

The present invention relates to an improved food vending machine equipped with a remote nutrition informing system, comprising a nutrition informational display providing at least one category identifier representative of a dietary category of food along with a corresponding brief description and at least one food item which has a label associated to it, the label displaying all category identifiers that is represented in the at least one food item.

### BACKGROUND OF THE INVENTION

The present invention generally relates to an improved vending machine that includes a nutrition classification system to provide classification information for each food or drink item in the vending machine.

Vending machines provide a unique and needed market for selling food or snack items, whether solid food or drink, in a local environment without the need for manual oversight. It is generally known that a user can view available food items through a display window and select the desired food item based on what the user sees. Selection and dispensing occurs in response to direct consumer input and without the need for a clerk or salesperson to act as the intermediary to complete the sale. By eliminating the human intermediary, vending machines have the benefit of permitting unattended sales at all hours.

Typically, money is deposited into the vending machine and the desired item is selected. Then the selected item is released into a receiving area for pickup and change, if any, is returned to the customer. Once the item is released for pickup, another item is made available for purchase using the same selection, except when another item is not stocked.

While transactions are facilitated automatically, vending machines do require regular restocking of food items. Also, manual intervention is needed to collect the paid-in money and to make sure that change is available. In addition to this regular maintenance, the vending machine will require repair service as the vending machine may experience mechanical problems that hinder transactions.

Despite all these benefits provided by available vending machines, there is still a great limitation experienced by customers who are conscientious about the dietary content of the food items they are purchasing. Some customers go beyond conscientious and have serious health concerns based on specific ingredients in food, e.g., diabetics and people with food allergies. This is due to the accessibility-limitations inherent and necessary in vending machines. Vending machines necessarily prevent consumers from handling the food or beverage items before the sale, thereby limiting or preventing the consumer to study nutritional information on the item's packaging. Thus, a customer is left to rely on his or her recollection of the item's nutritional information when deciding which food item to purchase. For example, a customer that is following a low-carbohydrate diet is interested in food items that have a low percentage of carbohydrate-base calories. Without having access to the nutritional contents of the item, one must rely upon his or her recollection in making a food selection consistent with his or her diet. Often times, the customer simply will forgo making a purchase so that money is not wasted on an item that violates the customer's diet.

Accordingly, there still remains a need for a vending machine equipped with a remote nutrition informing system that allows a customer to quickly get diet-specific information about available food items in order to select the most appropriate food item.

### SUMMARY OF THE INVENTION

The present invention addresses the above-mentioned needs in the art and, more specifically, includes an improved vending machine having with a remote nutrition informing system.

One aspect of the invention is an improved food vending machine equipped with a remote nutrition informing system. The term “remote” is intended to mean that the nutritional information is displayed separate from the food or beverage item or its packaging; thereby making such information available to consumers, which otherwise would not have been available prior to purchase. The remote nutrition informing system provides a system for remotely informing purchasers of general nutritional content of food items available for purchase in a vending machine. Normally, the purchaser has to rely upon memory to have any idea of desired nutritional information prior to purchase.

In one aspect of the present invention, the remote nutrition informing system includes a nutrition informational display and a label. The nutrition informational display is incorporated into the improved vending machine either at the point of manufacture or can be retrofit onto existing vending machines. The nutrition informational display and label can be either printed or embossed script or electronically displayed. The nutrition informational display includes a plurality of dietary categories. Preferably, a dietary category identifier is also displayed wherein each dietary category identifier corresponds to one dietary category, exclusively. In addition, a label is associated with each of the food items stocked in the vending machine for purchase. The label displays a dietary category identifier that corresponds to the dietary category into which a particular food item is categorized. Categorizing the food items into dietary categories facilitates communicating nutritional information in such a manner as to permit a purchaser to make a rapid determination whether a particular item in the vending machine fits a nutritional profile that is consistent with the purchaser's specific dietary plan. The nutrition informational display may be attached to or otherwise associated with a display window in the vending machine to permit easy viewing by the purchaser. Optionally, the nutrition informational display can be attached onto a panel of the vending machine, preferably in the near vicinity of a selection input means, such as a push key for selecting an item to be dispensed. The item labels may be made any material that is readily attached to packaging for each food item or in proximity to the food item, such as on a shelf holding a plurality of like food items. Each item label displays a category identifier corresponding to the particular food category to which the labeled food item belongs. The item labels include, without limitation, a sticker, pin, button, decal, flag, or other similar small display means.

In accordance with another aspect of the present invention, an improved food vending machine having a remote nutrition informing system further includes an electronic check system. The electronic check system is electronically associated with a selection input device for selecting a food item. The electronic check system allows a purchaser to enter a category identifier and prevents the purchase of a food item that does not fit the selected category identifier. This prevents the purchaser from erroneously purchasing a food item that does not fit the dietary category selected.

Yet another aspect of the present invention is a method of selecting a food item that is available for purchase in an improved food vending machine having a remote nutrition informing system based on a desired dietary category. The selection process includes reviewing the nutrition information display to determine the category identifier that corresponds to a desired dietary category, searching for a food item with a label displaying the category identifier that signifies the desired dietary category, and selecting the food item from the improved vending machine for purchase.

In yet another aspect of the present invention, the inventive selection method further comprises the step of entering the category identifier in the selection input device prior to selecting the food item for purchase, and checking that the selected food item matches the entered category identifier, wherein if the selected food item does not match the entered category identifier, the selected food item is prevented from purchase.

In a further aspect of the present invention, the improved food vending machine is comprised of an interactive graphic interface for displaying the at least one dietary category and allowing selection of the at least one dietary category, wherein upon selection the interactive graphic interface displays a list of food items that are available for purchase and fit the selected dietary category. In a preferred embodiment, the interactive graphic interface also displays a category identifier and a desired dietary category is chosen by selecting the corresponding category identifier.

These aspects and additional aspects of the present invention will be understood by one of ordinary skill upon reviewing the provided disclosure along with the drawings.

### BRIEF DESCRIPTION OF THE DRAWINGS

FIG. 1 illustrates a front view of an improved vending machine including the remote nutrition informing system.

FIG. 2 illustrates a front view of an input selection device having a checking system included.

FIG. 3 illustrates a front view of an input selection device having an interactive dietary category matching interface.

FIG. 4 illustrates one embodiment of a nutrition informational display of the present invention.

FIG. 5 illustrates an alternative embodiment of a nutrition informational display of the present invention.

### DETAILED DESCRIPTION OF THE PREFERRED EMBODIMENTS

The present invention generally relates to an improved vending machine equipped with a remote nutrition informing system. The remote nutrition informing system provides a quick and simple system for a purchaser to make a nutritional evaluation of the various food items available in the vending machine. This is particularly important because the purchaser is not able to handle the food items before purchase due to the lack of manual oversight. This prevents the purchaser from viewing the nutritional content information on the packaging of the food items. In addition, the disclosed remote nutrition informing system also provides a selection of dietary categories to the purchaser and informs the purchaser of which food items fall under each of the dietary categories. Equipped with this nutritional information, the purchaser is no longer limited when choosing a food item and can rest assure that the purchaser is selecting a diet-compliant food item

The diet categories can be chosen from a number of popular diets and traditional diets. Diet categories preferably include, without limitation: high fiber, low fat, high protein, soy protein, low carbohydrate, ATKINS, Zone 40-30-30 (40% carbohydrate-30% protein-30% fat), meal replacement, pre-workout with or without caffeine, organic, low sugar, low calorie, vitamin enhanced, creatine, and other known diets. One particular embodiment includes a remote nutrition informing system having a nutrition informing display that is attached to the window display, panel, or other area on the front of the vending machine that is in prominent view of the purchaser. The nutrition informing display provides a number of dietary categories with a brief description and a category identifier that corresponds to one dietary category, exclusively. The nutritional informing display may be either a pre-printed sign or label, or may be an electronic or electromechanical display.

The category identifier is a unique code that represents the corresponding dietary category, e.g., low carbohydrate diet would have a category identifier such as Lcarb, LowCarb, or LC. The category identifier is displayed on each food item that falls under the dietary category that the particular category identifier represents. The category identifier can be displayed on the food item itself, or on an area of the shelf that the food item sits on that would uniquely mark that particular food item.

In an alternative embodiment, the remote nutrition informing system includes a electronic checking system that allows the purchaser to enter in a category identifier that represents the dietary category the purchaser desires. The electronic checking system is electronically connected to the input selection device that is generally available on vending machines. The purchaser selects a category identifier on the electronic checking system and then selects the desired food item with the input selection device. If the selected food item does not fit the dietary category represented by the selected category identifier, then the purchase of the selected food item is not permitted. In an alternative embodiment, the purchaser is given a second chance to make the same purchase despite the nonmatch with the dietary category. This lets the purchaser circumvent the electronic checking system.

In another alternative embodiment, the remote nutrition informing system includes an interactive graphic interface (“IGI”) for making dietary category selections. The IGI displays the category identifiers as boxed items, which the purchaser can choose by selecting the box with the desired category identifier. Upon making the selection, the purchaser is given a choice of available items in the vending machine that are consistent with the selected category identifier and associated dietary category. In accordance with a preferred embodiment of the invention, the item choices have corresponding codes which are input into the input selection device, such as by a computer system electrically interfaced with the IGI. Such item codes may be associated in a database with an items UPC (Universal Product Code) such that inputting of an items UPC into the computer system causes a look up function to identify the corresponding dietary category code which is then output to the IGI from the computer system. Alternatively, a bar code may be placed on each item which is then directly scanned into the IGI to load the dietary category identifier code into the IGI. Each time the vending machine is stocked with food items, the appropriate category identifiers that match each of the stocked food items must be downloaded onto the computer system, preferably in a current food item database. Once the purchaser selects a desired category identifier, the computer system can match the desired category identifier with the food items using the current food item database. As an alternative, the category identifier can be eliminated and the dietary category itself can be displayed on the IGI and the purchaser can select the desired dietary category.

In yet another embodiment, the remote nutrition informing system includes an IGI with an additional functionality that allows the purchaser to enter in the code corresponding to a food item to retrieve electronic labels or electronic tags containing the category identifiers. The purchaser can enter in the code of the desired food item using the selection input device, or alternatively on the IGI itself, which results in the display of the label for that particular food item. The label includes the category identifier for that food item, which informs the purchaser what dietary category the food item falls within. This process, to obtain nutritional information, can be repeated by the purchaser for any of the additional available food items. Based on this information, the purchaser can make a purchase equipped with this nutritional information and comply with any dietary concerns. In a further alternative embodiment, the nutrition informational display is electronic and displayed on the IGI. The electronic labels can provide the dietary categories, but preferably, the electronic labels provide the category identifiers.

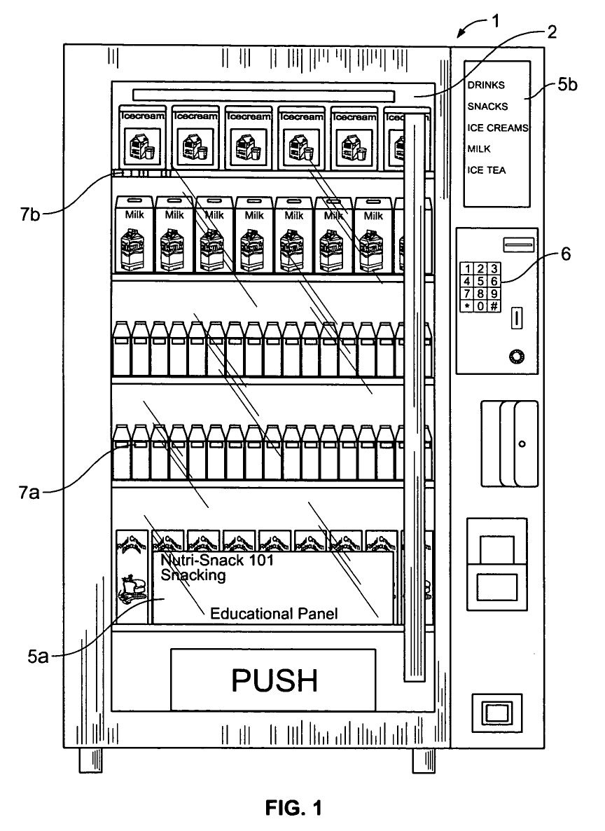

FIG. 1 shows the front view of an improved vending machine 1 equipped with the remote nutrition informing system. The improved vending machine includes the mechanical and electrical components that allow a purchaser to input money and select a food item using a input selection device 6, or keypad, and retrieve the selected food item with change returned, if any. In the improved vending machine 1, a nutrition informing panel 5a is attached to the window display 2 in a manner that does not obstruct the view of the food items. An alternative nutrition informing panel 5b is shown affixed on a panel near the input selection device 6. The nutrition informing panel 5a, 5b provides a list of dietary categories along with a brief description and a corresponding unique category identifier. A label 7a is shown affixed to one of the food items and adjusted so that the label 7a is in direct view through the window display. Alternatively, a label 7b is affixed to a shelf so that it is in direct view through the window display and is on an area of the shelf that corresponds to that specific food item. The label 7a, 7b display category identifiers that correspond to one dietary category, exclusively. The category identifiers can be a unique code that is reflective of the corresponding dietary category, or it can be a unique color or symbol. The purchaser can determine the dietary category that the purchaser desires by viewing the nutrition informing display 5a, 5b. Once determine, the purchaser can view which category identifier corresponds to the desired dietary category. At this point, the purchaser looks to see which of the available food items match the desired dietary category by looking for labels 7a, 7b that have the corresponding category identifier and select accordingly.

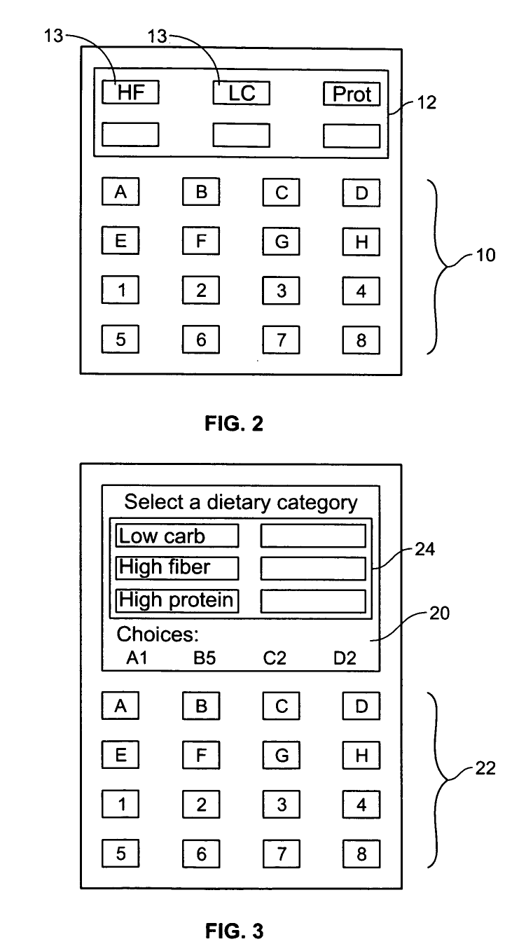

FIG. 2 shows the front view of an input selection device 10 that has an electronic checking system 12 included. Labels 13 are provided as keys that can be selected based on desired dietary category. The labels 13 have the dietary category imprinted onto its surface. Preferably, the labels 13 have the category identifier imprinted onto its surface. Once the desired label 13, based on the desired dietary category, is selected, the purchaser then selects the food item using the input selection device 10. If the food item does not fit the selected dietary category, the purchase of the food item is prevented. Optionally, the purchaser can circumvent this checking system by reselecting the same food item despite the nonmatch with the desired dietary category.

FIG. 3 shows the front view of part of a panel of an improved vending machine including an interactive graphic interface (“IGI”) 20 and a selection input device 22. The IGI displays the category identifiers as electronic tags or labels, ID boxes 24, which the purchaser can choose by touching the appropriate ID box 24. Upon making the selection, the purchaser is given a choice of food items available that fits the dietary category represent by the chosen category identifier. Preferably, the choice of food items is given as codes to be inputted into the input selection device. This embodiment requires a computer system electronically connected to the IGI. Each time the vending machine is stocked with food items, the appropriate category identifiers that match each of the stocked food items must be downloaded onto the computer system, preferably in a current food item database. Once the purchaser selects a desired category identifier, the computer system can match the desired category identifier with the food items using the current food item database. As an alternative, the category identifier can be eliminated and the dietary category itself can be displayed on the IGI and the purchaser can select the desired dietary category.

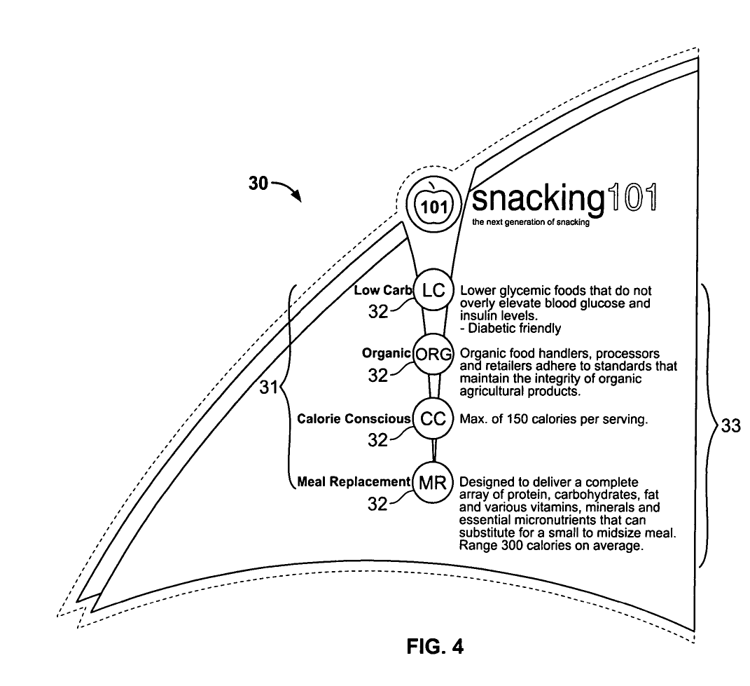

FIG. 4 illustrates one embodiment of a nutrition informational display of the present invention. The nutrition information display 30 shows a number of dietary categories 31 and category identifiers 32 that are associated with each dietary category 31, exclusively. For example, the low carb dietary category is identified by the category identifier LC. Each dietary category 31 is also provided with a brief description 33. The nutrition information display 30 can be displayed on the improved food vending machine as part of a display sheet or a stick-on peel-away adhesive.

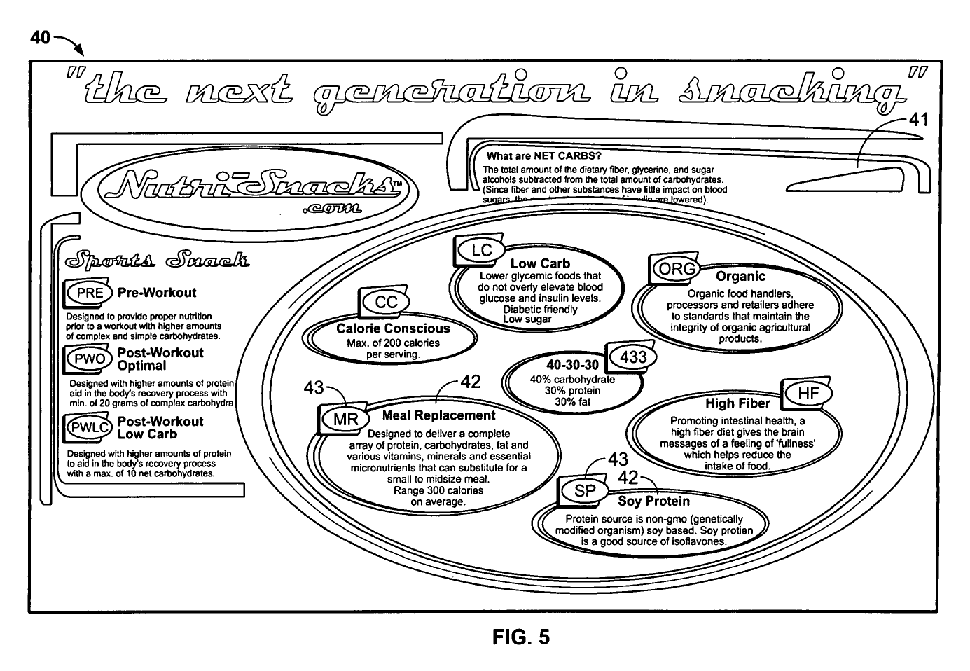

FIG. 5 illustrates an alternative embodiment of a nutrition informational display of the present invention. The nutrition information display 40 shows a quick nutrition message 41 for the consumer, which helps educate the consumer on dieting and proper snacking. Dietary categories 42 are provided along with their corresponding category identifier 43. For example, the dietary category Meal Replacement is identified by the category identifier MR. Optionally, a group of dietary categories can be listed under a more general dietary group, e.g., Sports Snack group including pre-workout, post-workout optimal and post-workout low carb.

While the foregoing describes the present invention with reference to its preferred embodiments, those of ordinary skill in the art will understand that the description is merely illustrative in nature and is not to be considered limiting.

1. An improved food vending machine for selling food items, comprising:
a nutrition informational display displaying a dietary category of food; and
a label corresponding to a food item displaying a dietary category represented in the food item.

2. The improved food vending machine according to claim 1, wherein the nutrition informational display further displays a category identifier that is representative of a dietary category.

3. The improved food vending machine according to claim 1, wherein the display further provides a brief description of the dietary category.

4. The improved food vending machine according to claim 2, further comprising an electronic check system in electronic communication with a selection input device for selecting a food item, the electronic check system allowing a purchaser to enter a category identifier and preventing the purchase of a food item that does not fit the selected category identifier.

5. The improved food vending machine according to claim 2, wherein the nutrition informational display comprises printed material coupled to the vending machine.

6. The improved food vending machine according to claim 2, wherein the display further comprises embossed material affixed on the vending machine proximate a user selection input on the vending machine.

7. The improved food vending machine according to claim 2, wherein the dietary category is selected from a group consisting of: high fiber, low fat, high protein, soy protein, low carbohydrate, ATKINS, Zone 40-30-30, meal replacement, pre-workout with caffeine, pre-workout without caffeine, organic, low sugar, low calorie, vitamin enhanced, and creatine supplement.

8. The improved food vending machine according to claim 2, wherein the label is selected from the group of adhesive label, pin, button, decal, flag and electronic tag.

9. The improved food vending machine according to claim 1, wherein the nutritional information display is comprised of an interactive graphic interface, the interactive graphic interface in electronic communication with a selection input device.

10. The improved food vending machine according to claim 2, wherein the nutritional information display is comprised of an interactive graphic interface, the interactive graphic interface in electronic communication with a selection input device.

11. The improved food vending machine according to claim 10, wherein the interactive graphic interface displays the label.

12. An improved food vending machine equipped with a remote nutrition informing system, comprising:
a nutrition informational display providing at least one category identifier representative of a dietary category of food,
an interactive graphic interface for displaying the at least one category identifier and allowing selection of the at least one category identifier, wherein upon selection the interactive graphic interface displays a list of food items that are available for purchase and fit the dietary category represented by the at least one category identifier.

13. A method of selecting a food item that is available for purchase in an improved food vending machine based on a desired dietary category, wherein the improved food vending machine includes a nutrition informational display to convey to a purchaser at least one category identifier and the dietary category it represents and a label for marking the food item with a category identifier that corresponds to the dietary category the food item is representative of, comprising the steps of:
reviewing the nutrition information display to determine the category identifier that corresponds to a desired dietary category,
searching for a food item with a label displaying the category identifier that signifies the desired dietary category, and
selecting the food item from the improved vending machine for purchase.

14. The method according to claim 13, wherein the improved vending machine includes a selection input device having an electronic check system allowing a purchaser to enter a category identifier and preventing the purchase of a food item that does not fit the selected category identifier, further comprising the step of
entering the category identifier in the selection input device prior to selecting the food item for purchase, and
checking that the selected food item matches the entered category identifier,
wherein if the selected food item does not match the entered category identifier, the selected food item is prevented from purchase.

15. The method according to claim 13, wherein the improved vending machine includes an interactive graphic interface for viewing electronic labels, further comprising the step of
entering the category identifier available on the interactive graphic interface to display the food items available that fall under the dietary category represented by the category identifier, and
selecting a food item from the displayed available food items.

16. An improved food vending machine, comprising:
a plurality of dietary category indicia corresponding to items in the vending machine; and
a display displaying at least one of the plurality of dietary category indicia.

17. The improved food vending machine according to claim 16, wherein the display further includes nutritional information representative of at least one category identifier representative of an item's dietary category and further comprising a label associated with each food item in the vending machine, the label displaying all dietary category identifiers applicable for the associated food item.

18. The improved food vending machine equipped with a remote nutrition informing system according to claim 16, wherein the display further provides a brief description of the dietary category.

19. The improved food vending machine according to claim 17, wherein the dietary category is selected from a group consisting of: high fiber, low fat, high protein, soy protein, low carbohydrate, ATKINS, Zone 40-30-30, meal replacement, pre-workout with caffeine, pre-workout without caffeine, organic, low sugar, low calorie, vitamin enhanced, and creatine supplement.

20. The improved food vending machine according to claim 16, further comprising an interactive graphical interface responsive to user input of at least one of an item selection, a dietary category selection and a dietary category indicia to display at least one of eligible items, nutritional information, and eligible dietary categories.
